(19) United States
(12) Patent Application Publication
(10) Pub. No.: US 2012/0262386 A1
(43) Pub. Date: Oct. 18, 2012

(54) TOUCH BASED USER INTERFACE DEVICE AND METHOD

(76) Inventors: Hyuntaek Kwon, Seoul (KR); Kangsoo Seo, Seoul (KR)

(21) Appl. No.: 13/308,680

(22) Filed: Dec. 1, 2011

(30) Foreign Application Priority Data
Apr. 15, 2011 (KR) 10-2011-0035180

(51) Int. Cl. G06F 3/041

(52) U.S. Cl. 345/173

(57) ABSTRACT

A touch based user interface method and device includes sensing a first touch on a touch screen in which at least a part of a circle is drawn, displaying a circular graphical user interface (GUI) object according to the sensed first touch gesture, sensing a second touch gesture on the touch screen through the displayed circular GUI object, and generating an event corresponding to the second touch gesture.

This application claims the benefit of Korean Patent Application No. 10-2011-0035180, filed on Apr. 15, 2011, which is hereby incorporated in its entirety by reference as if fully set forth herein.

### BACKGROUND OF THE INVENTION

1. Field of the Invention

The present invention relates to a touch-based user interface device and method, and more particularly, to a touch-based user interface device and method using a multi-touchscreen.

2. Discussion of the Related Art

Recently, there are various types of input devices to input a user command to user interface devices including multi-media reproduction devices. The user command may be expressed as a selection operation on a display screen by moving a cursor, and such an operation may implement the user command, such as paging, scrolling, panning or zooming. These input devices include a button, a switch, a keyboard, a mouse, a track ball, a touch pad, a joy stick, a touchscreen, etc.

From among the input devices, the touchscreen has several advantages as compared to other input devices, such as the touch pad, the mouse, etc. One advantage of the touchscreen is that the touchscreen is disposed in front of a display device and thus a user directly operates a graphical user interface (GUI). Therefore, the user may achieve more intuitive input using the GUI.

Another advantage of the touchscreen is that a multi-point input technique to implement simultaneous recognition of several touch points is applied to the touchscreen. Thereby, the user may execute a wider variety of operations using such a touchscreen than recognition of one touch point. That is, a multi-touchscreen may designate reaction of the device to touch according to the number of the touch points and achieve operation through interval change of the touch points, differing from the conventional touch method in which only position change through touch is input and thus in order to execute various operations, separate operation of, for example, a sub-button is required, thereby providing a more intuitive and easy user interface.

In the above multi-touchscreen, a gesture of spreading or closing two fingers is used to zoom in on or out of a Web page or a photograph. However, as a wider variety of applications is recently provided, a touch gesture input method which is more intuitive and executes various functions using multi-touch is needed.

### SUMMARY OF THE INVENTION

Accordingly, the present invention is directed to a touch-based user interface device and method.

An object of the present invention is to provide a touch-based user interface device and method which is more intuitive and to which a wider variety of applications is applicable.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve this object and other advantages and in accordance with the purpose of the invention, as embodied and broadly described herein, a touch based user interface method includes sensing a first touch gesture on a touch screen in which at least a part of a circle is drawn, displaying a circular graphical user interface (GUI) object according to the sensed first touch gesture, sensing a second touch gesture on the touch screen through the displayed circular GUI object, and generating an event corresponding to the second touch gesture.

The first touch gesture may include rotating gestures simultaneously generated at two touch points such that the at least a part of the circle is drawn in each of the rotating gestures.

The sensing of the first touch gesture may include judging whether or not a central point between the two touch points is within a first error range during execution of the rotating gestures, and judging whether or not a distance between the two touch points is maintained within a second error range during execution of the rotating gestures.

The first touch gesture may include a fixed touch gesture generated at a first touch point and a rotating gesture generated at a second touch point simultaneously with the fixed touch gesture.

The sensing of the first touch gesture may include judging whether or not a distance between the first touch point and the second touch point is maintained within a third error range during execution of the fixed touch gesture and the rotating gesture.

The second touch gesture may be a gesture of contacting and rotating the circular GUI object.

The touch based user interface method may further include detecting rotating speed and direction of the second touch gesture, and rotating the circular GUI object according to the rotating speed and direction of the second touch gesture.

A progressing speed of the event may be adjusted according to the rotating speed and direction of the second touch gesture.

The touch based user interface method may further include sensing completion of the second touch gesture and removing the circular GUI object after a predetermined time from completion of the second touch gesture has elapsed.

The circular GUI object may have a semi-transparent color.

In another aspect of the present invention, a touch based user interface device includes a display unit to provide a circular graphical user interface (GUI), a touch detection unit to sense touch gestures of a user through the GUI, and a control unit to generate events respectively corresponding to the touch gestures, wherein the touch detection unit senses a first touch gesture on a touch screen in which at least a part of a circle is drawn, the control unit controls the display unit so as to display a circular GUI object according to the sensed first touch gesture, the touch detection unit senses a second touch gesture on the touch screen through the displayed circular GUI object, and the control unit generates an event corresponding to the second touch gesture.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a flowchart illustrating a touch based user interface method in accordance with a first embodiment of the present invention;

FIG. 2 is a view schematically illustrating input of a first touch gesture by a user in the touch based user interface method in accordance with the first embodiment of the present invention;

FIG. 3 is a flowchart illustrating a method of sensing the first touch gesture of the user in the touch based user interface method in accordance with the first embodiment of the present invention;

FIG. 4 is a view schematically illustrating the method of sensing the first touch gesture of the user in the touch based user interface method in accordance with the first embodiment of the present invention;

FIG. 5 is a view schematically illustrating display of a circular graphical user interface object in the touch based user interface method in accordance with the first embodiment of the present invention;

FIG. 6 is a view schematically illustrating input of a second touch gesture using the circular graphical user interface object in the touch based user interface method in accordance with the first embodiment of the present invention;

FIG. 7 is a flowchart illustrating a method of sensing the second touch gesture in the touch based user interface method in accordance with the first embodiment of the present invention;

FIGS. 8 to 11 are views schematically illustrating generation of events using the touch based user interface method in accordance with the first embodiment of the present invention;

FIG. 12 is a view schematically illustrating removal of the circular graphical user interface object in the touch based user interface method in accordance with the first embodiment of the present invention;

FIG. 13 is a view schematically illustrating input of a first touch gesture by a user in a touch based user interface method in accordance with a second embodiment of the present invention;

FIG. 14 is a flowchart illustrating a method of sensing the first touch gesture of the user in the touch based user interface method in accordance with the second embodiment of the present invention;

FIG. 15 is a view schematically illustrating the method of sensing the first touch gesture of the user in the touch based user interface method in accordance with the second embodiment of the present invention; and

FIG. 16 is a block diagram illustrating a touch based user interface device in accordance with one embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In the embodiments of the present invention, a user inputs a desired command using a circular graphical user interface (GUI) object.

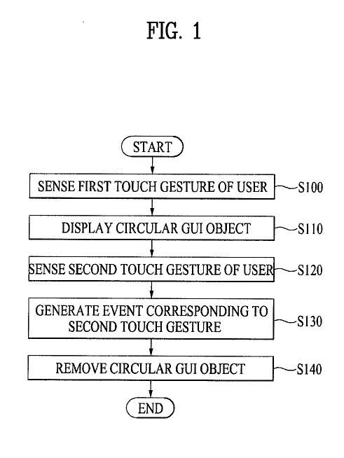

FIG. 1 is a flowchart illustrating a touch based user interface method in accordance with a first embodiment of the present invention.

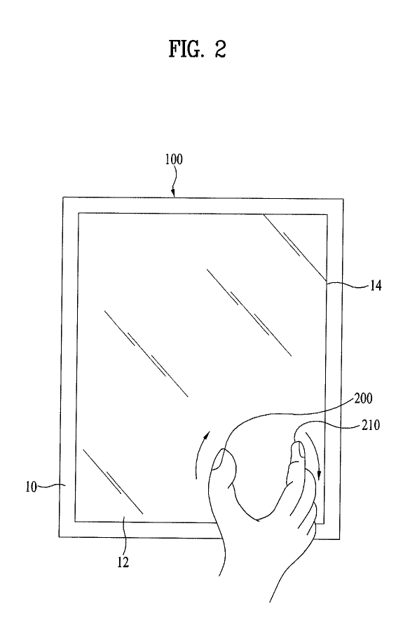

As shown in FIG. 1, the touch based user interface method in accordance with the first embodiment includes sensing a first touch gesture of a user in which at least a part of a circle is drawn (Operation S100), displaying a circular graphical user interface (GUI) object 16 according to the sensed first touch gesture (Operation S110), sensing a second touch gesture of the user through the displayed circular GUI object 16 (Operation S120), generating an event corresponding to the second touch gesture (Operation S130), and removing the circular GUI object 16. Hereinafter, the above operations will be described in detail with reference to FIGS. 2 to 12.

First, the first touch gesture of the user in which at least the part of the circle is drawn is sensed. FIG. 2 is a view schematically illustrating input of the first touch gesture by the user using a user interface device 100 in the touch based user interface method in accordance with the first embodiment of the present invention.

The user interface device 100 includes a display unit 10 to provide a graphical user interface (GUI) 12 and a touch detection unit 14 provided on the display unit 10 to enable the user to input a touch gesture. A configuration of such a user interface device 100 will be described later.

As shown in FIG. 2, the user who intends to input a command using the circular GUI object 16 puts two fingers 200 and 210 on the touch detection unit 14 to execute the first touch gesture. Here, the user may locate the fingers 200 and 210 at random positions on the touch detection unit 14. The user simultaneously executes rotating gestures of the fingers 200 and 210 at two touch points where the fingers 200 and 210 are located, in the same direction, and if such gestures correspond to rotating gestures simultaneously generated at the two points such that at least a part of the circle is drawn in each of the rotating gestures, the gestures of the user are judged as the first touch gesture.

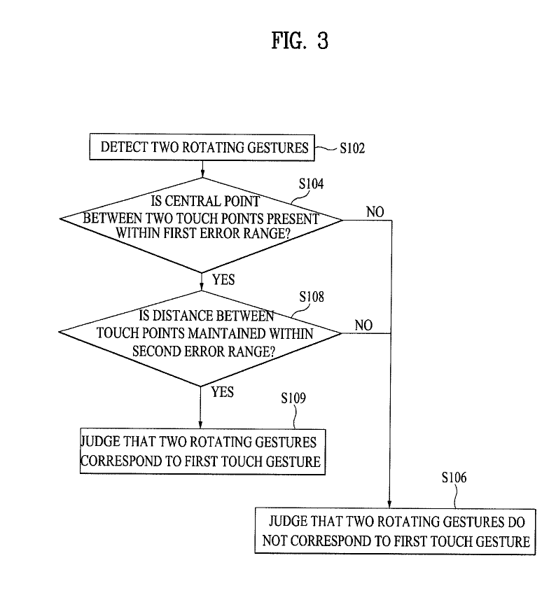

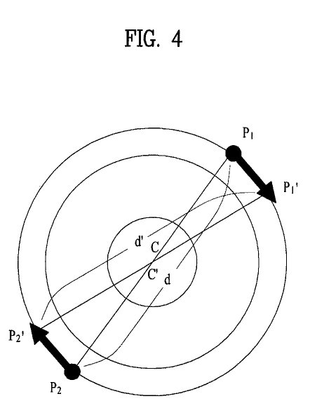

FIGS. 3 and 4 are a flowchart and a view illustrating a method of sensing the first touch gesture of the user in the touch based user interface method in accordance with the first embodiment of the present invention. Hereinafter, a method of judging the first touch gesture will be described in detail.

As shown in FIG. 3, whether or not the gestures of the user correspond to the first touch gesture, i.e., whether or not user's intention to use the circular GUI object 16 is present is judged, for example, by detecting at least two rotating gestures by the two fingers 200 and 210 of the user (Operation S102), judging whether or not a central point between the two touch points is within a first error range during execution of the rotating gestures (operation S104), and judging whether or not a distance between the two touch points is maintained within a second error range during execution of the rotating gestures (Operation S108).

That is, as shown in FIG. 4, when the user executes a gesture of moving the two fingers from two initial touch points P₁ and P₂ to points P₁′ and P₂′ rotated from the initial points P₁ and P₂ at a random angle, whether or not the following conditions are satisfied during execution of the rotating gestures of the user is judged.

Abs(C−C′)<e₁ [Equation 1]

Abs(d−d′)<e₂ [Equation 2]

Here, Abs means an absolute value function, C means the central point between the initial touch points P₁ and P₂, C′ means the central point between the random touch points P₁′ and P₂′ during execution of the gestures, d means the distance between the initial touch points P₁ and P₂, and d′ means the distance between the random touch points P₁′ and P₂′ during execution of the gestures. Further, e₁ and e₂ respectively represent the first error range and the second error range, and may be properly set as needed.

If the above conditions are satisfied, the gestures of the user are judged as the rotating gestures simultaneously generated at the two touch points such that at least a part of a circle is drawn in each of the rotating gestures (Operation S109).

If one of the above conditions is not satisfied, the gestures of the user are not judged as the first touch gesture, but are judged as a gesture indicating another user's intention or a gesture not intended by the user (Operation S106).

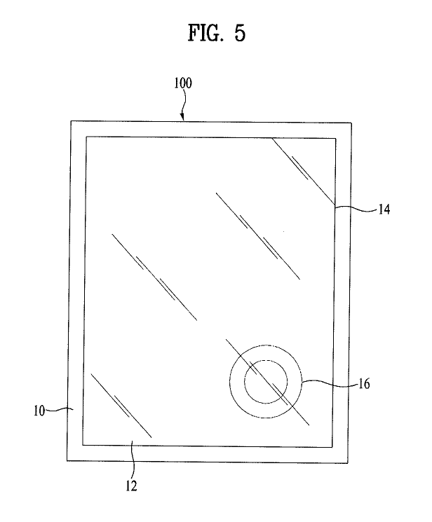

Thereafter, the circular GUI object 16 is displayed according to the sensed first touch gesture. FIG. 5 is a view schematically illustrating display of the circular GUI object in accordance with this embodiment. As shown in FIG. 5, the circular GUI object 16 may be displayed on the display unit 10 so as to have a semitransparent color.

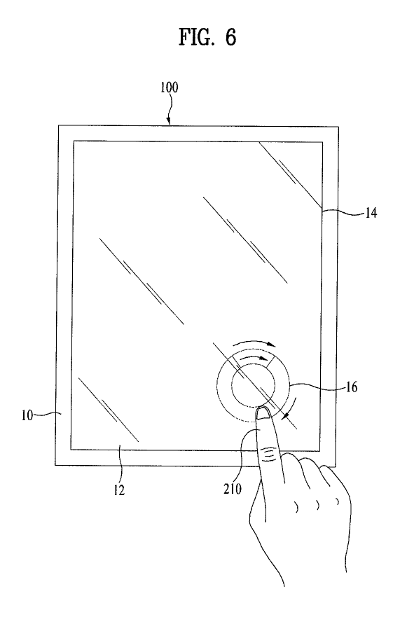

Thereafter, a second touch gesture of the user through the displayed circular GUI object 16 is sensed, and an event corresponding to the second touch gesture is generated. FIG. 6 is a view schematically illustrating input of the second touch gesture using the circular GUI object in accordance with this embodiment.

When the user, using the finger 210, initially touches the circular GUI object 16 or a position around the circular GUI object 16, it is judged that the circular GUI object 16 is related with the finger 210. Thereby, the circular GUI object 16 is changed according to the gesture of the user finger 210. By relating the finger 210 with the circular GUI object 16, as described above, the circular GUI object 16 is continuously changed on the touch detection unit 14 according to the gesture of the finger 210.

As shown in FIG. 6, the second touch gesture may be a touch gesture of the user touching and rotating the circular GUI object 16. Although FIG. 6 exemplarily illustrates rotation of the circular GUI object 16 by the user using one finger 210, rotation of the circular GUI object 16 by the user using two fingers 200 and 210, as shown in FIG. 2, may be executed. That is, by executing the first touch gesture, as described above, the user may input the second touch gesture through continuous motion with the first touch gesture when the GUI object 16 is displayed. Alternatively, after the first touch gesture is executed and the circular GUI object 15 is displayed, the second touch gesture is input through discontinuous motion from the first touch gesture.

Here, rotation of the circular GUI object 16 may be adjusted according to a rotating amount of the finger 210. That is, if a gesture of rotating the finger 210 by an angle of 10 degrees is input, a state in which the circular GUI object 16 is rotated by the angle of 10 degrees may be displayed. Rotation of the circular GUI object 16 may be carried out simultaneously with rotation of the finger 210. That is, the circular GUI object 16 may be rotated by an angle of 1 degree almost simultaneously with rotation of the finger 210 by the angle of 1 degree.

Further, in this instance, an acoustic feedback of rotation per unit may be provided according to the above rotation of the circular GUI object 16. For example, a click sound may be provided five times based on rotation by an angle of 10 degrees. Further, a vibration feedback or other tactile feedback having a designated amount to respective a click sound may be provided, thereby enabling the virtual circular GUI object 16 to simulate operation of an actual dial.

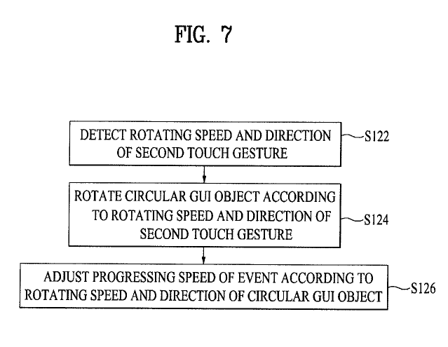

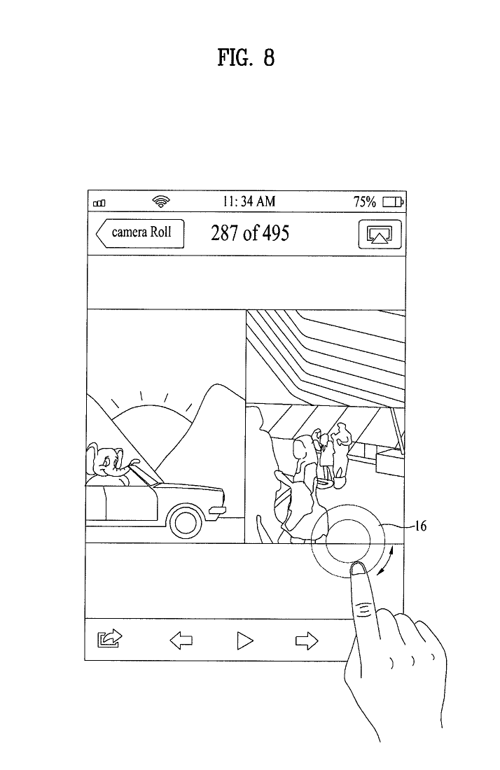

FIG. 7 is a flowchart illustrating a method of sensing the second touch gesture in accordance with this embodiment, and FIGS. 8 to 11 are views schematically illustrating generation of events using the touch based user interface method in accordance with the first embodiment of the present invention, respectively.

As shown in FIG. 7, the method of sensing the second touch gesture includes detecting rotating speed and direction of the second touch gesture (Operation S122), rotating the circular GUI object 16 according to the rotating speed and direction of the second touch gesture (Operation S124), and adjusting progressing speed and direction of an event according to rotating speed and direction of the circular GUI object 16 (Operation S126).

That is, for example, if the circular GUI object 16 is a GUI to search a plurality of photographs, as shown in FIG. 8, the rotating speed of the second touch gesture may correspond to a scroll amount of the photographs and the rotating direction of the second touch gesture may correspond to a scroll direction of the photographs.

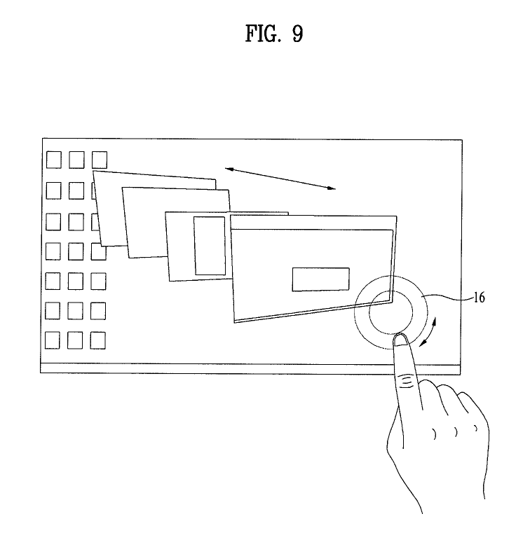

As shown in FIG. 9, the circular GUI object 16 may be provided as a GUI to switch a multi-window screen. Here, the rotating speed of the second touch gesture may correspond to a window screen switching speed and the rotating direction of the second touch gesture may correspond to a window screen switching direction.

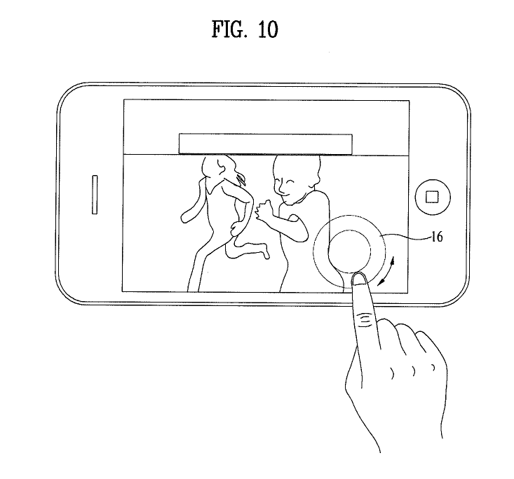

As shown in FIG. 10, the circular GUI object 16 may be provided as a GUI to search a moving image. In this instance, the rotating speed of the second touch gesture may correspond to a reproducing speed of the moving image and the rotating direction of the second touch gesture may correspond to a reproducing direction of the moving image.

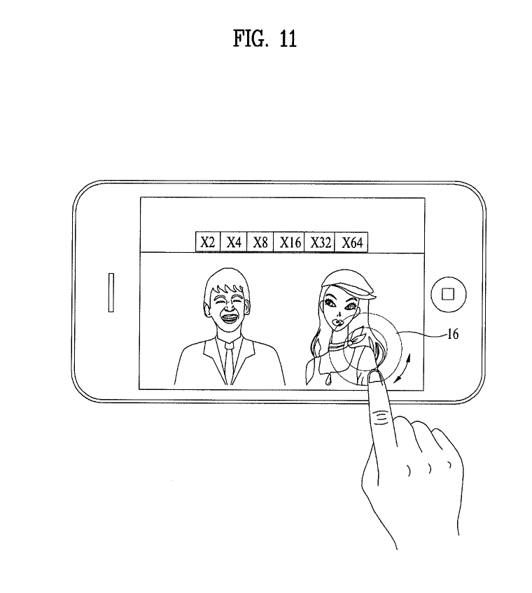

Further, as shown in FIG. 11, the circular GUI object 16 may be provided as a GUI to provide a zoom function of a digital camera. In this instance, a zoom-in/out event may be executed according to the rotating direction of the second touch gesture.

The above circular GUI object 16 may be applied to various other applications, and the present invention is not limited to the above-described applications. That is, during input of the first touch gesture, an event generated by the circular GUI object may be varied according to a mode of an apparatus to which the interface device is applied or a kind of application which is being executed.

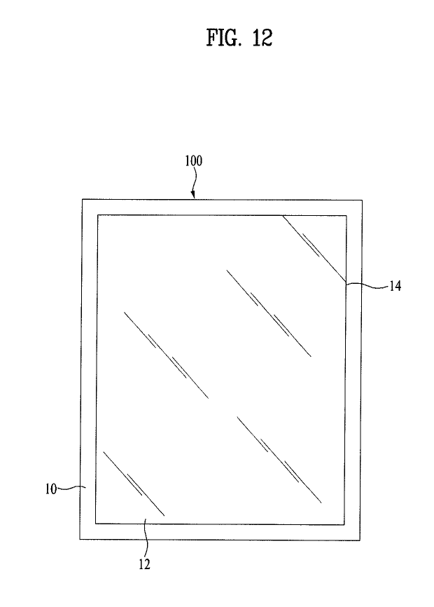

Thereafter, when completion of the second touch gesture is sensed and a predetermined time from completion of the second touch gesture has elapsed, the circular GUI object 16 is removed. If input of the second touch gesture has been completed or if the circular GUI object 16 is displayed by input of the first touch gesture and then the second touch gesture is not input, when a predetermined time, for example, 0.5 seconds, has elapsed, it is judged that there is no user's intention to input the second touch gesture, and thus the circular GUI object 16 is removed from the display unit 10, as shown in FIG. 12.

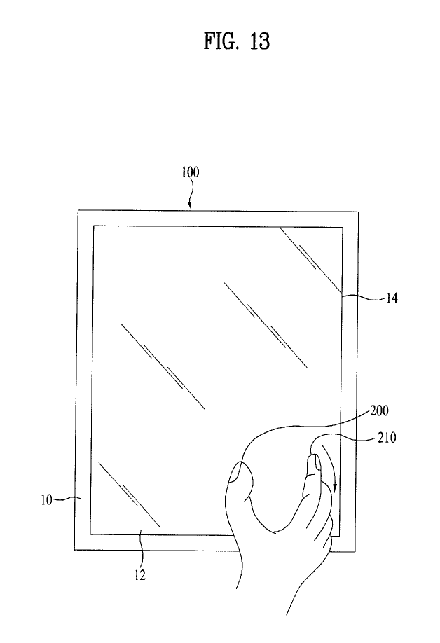

Hereinafter, with reference to FIGS. 13 to 15, a touch based user interface method in accordance with a second embodiment of the present invention will be described in detail. The second embodiment differs from the above-described first embodiment in terms of a method of sensing a first touch gesture. Further, the second embodiment is identical with the first embodiment in terms of other operations except for the method of sensing the first touch gesture, and a detailed description of these operations will thus be omitted.

FIG. 13 is a view schematically illustrating input of a first touch gesture by a user using an interface device 100 in the touch based user interface method in accordance with the second embodiment of the present invention. In this embodiment, the first touch gesture is defined as including a fixed touch gesture generated at a first touch point and a rotating gesture generated at a second touch point simultaneously with the fixed touch gesture.

As shown in FIG. 13, the user who intends to input a command using the circular GUI object 16 puts two fingers 200 and 210 on the touch detection unit 14 to execute the first touch gesture. Here, the user may locate the fingers 200 and 210 at random positions on the touch detection unit 14. The user fixes one finger 200 to a random position, and executes a rotating gesture of another finger 210.

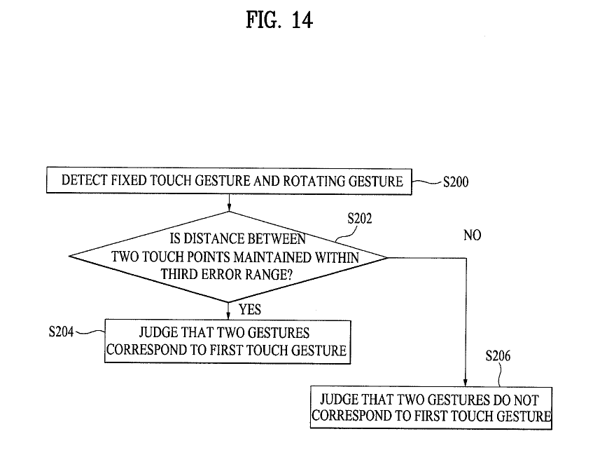

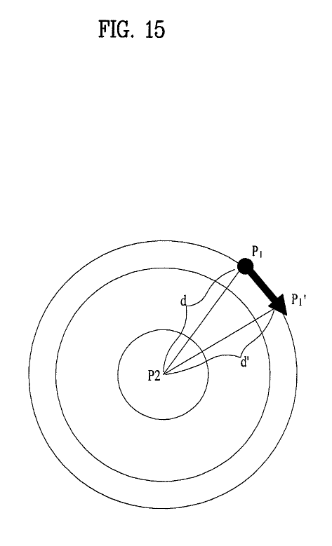

FIGS. 14 and 15 are a flowchart and a view illustrating a method of sensing the first touch gesture of the user in accordance with this embodiment. Hereinafter, a method of judging the first touch gesture will be described in detail.

As shown in FIG. 14, the method of sensing the first touch gesture in accordance with this embodiment includes detecting a fixed touch gesture and one rotating gesture (Operation 5200) and judging whether or not a distance between the first touch point and the second touch point is maintained within a third error range during execution of the gestures (Operation S202).

That is, as shown in FIG. 15, when the user executes a gesture of moving a finger from an initial touch point P₁ to a touch point P₁′ rotated from the initial touch point P₁ by a random angle, whether or not the following condition is satisfied during execution of the gestures of the user is judged.

Abs(d−d′)<e₃ [Equation 3]

Here, Abs means an absolute value function, d means the distance between the initial first touch point P₁ and the initial second touch point P₂, and d′ means the distance between a first touch point P₁′, rotated from the initial first touch point P₁ after a random time has elapsed during execution of the gestures or after execution of the gestures has been completed, and the second touch point P₂. Further, e₃ represents the third error range and may be properly set as needed.

If the above condition is satisfied, the gestures of the user are judged as the first touch gesture (Operation 204). On the other hand, if the above condition is not satisfied, the gestures of the user are not judged as the first touch gesture, but are judged as a gesture indicating another user's intention or a gesture not intended by the user (Operation S206).

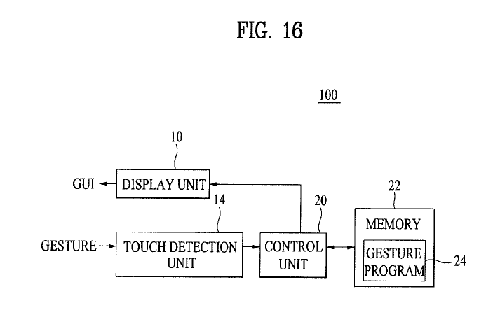

Hereinafter, a device to provide the above touch based user interface method will be described in detail. FIG. 16 is a block diagram illustrating a touch based user interface device 100 in accordance with one embodiment of the present invention.

The touch based user interface device 100 in accordance with the embodiment of the present invention may be applied to all electronic equipment requiring a user interface including a personal computer system, such as a desktop computer, a laptop computer, a tablet computer or a handheld computer, a smart phone, a mobile phone, a PDA, an exclusive media player, a TV, and home appliances.

As shown in FIG. 16, the touch based user interface device 100 in accordance with the embodiment of the present invention includes a display unit 10 to provide a GUI, a touch detection unit 14 to sense a touch gesture of a user, and a control unit 20 to generate an event corresponding to the touch gesture. The touch based user interface device 100 may further include a memory 22 to store a gesture program 24.

For example, the control unit 20 controls reception and processing of input and output data between elements of the user interface device 100 using a command searched from the memory 22.

The control unit 20 may be implemented on any suitable device, such as a single chip, multiple chips or multiple electrical parts. For example, an architecture including various elements, such as an exclusive or imbedded processor, a single purpose processor, a controller and an ASIC, may be used to constitute the control unit 20.

The control unit 20 executes operations of executing computer code and generating and using data together with an operating system. Here, any known operating system, such as OS/2, DOS, Unix, Linux, Palm OS, etc., may be employed as the operating system. The operating system, computer code and data may be present within the memory 22 connected to the control unit 20. The memory 22 provides a place in which the computer code and data generally used by the user interface device 100 are stored. For example, the memory 22 may includes a ROM, a RAM or a hard disc drive. Further, the data may be present in a separable storage medium and then the separable storage medium may be loaded or installed on the user interface device 100, as needed. For example, the separable storage medium includes a CD-ROM, PC-CARD, a memory card, a floppy disc, a magnetic tape or a network component.

The user interface device 100 includes the display unit 10 connected to the control unit 20. The display unit 10 may be any suitable display device, such as a liquid crystal display (LCD), an organic light emitting diode display (OLED) or a plasma display panel (PDP).

The display unit 10 is configured to display a GUI providing an interface easily used between a user and the operating system or an application being executed through the operating system.

The GUI expresses a program, a file and an operation option in graphic images. The graphic images may include windows, fields, dialog boxes, a menu, icons, buttons, cursors, scroll bars, etc. Such images may be arranged in a layout which is defined in advance, or be dynamically generated so as to assist a specific measure which is taken by the user. During operation of the user interface device 100, the user may select and activate the images in order to start functions and operations related with the graphic images. For example, the user may select a button to open, close, minimize or maximize a window or an icon to start a specific program. In addition to the graphic images or in substitute for the graphic images, the GUI may display data, such as non-interactive text and graphics, on the display unit 10.

The user interface device 100 includes the touch detection unit 14 connected to the control unit 20. The touch detection unit 14 is configured to transmit data from the outside to the user interface device 100.

For example, the touch detection unit 14 may be used to execute tracking and selection related with the GUI on the display unit 10. Further, the touch detection unit 14 may be used to generate a command of the user interface device 100.

The touch detection unit 14 is configured to receive input from user touch and to transmit the received data to the control unit 20. For example, the touch detection unit 14 may be a touch pad or a touchscreen.

Further, the touch detection unit 14 may recognize position and size of the touch on a touch sensing surface. The touch detection unit 14 reports the touch to the control unit 20, and the control unit 20 analyzes the touch according to the program of the control unit 20. For example, the control unit 20 may start an operation according to a specific touch. Here, in order to locally process the touch, a separate exclusive processor may be used in addition to the control unit 20. The touch detection unit 14 may employ any suitable sensing techniques including capacitive sensing, resistive sensing, surface acoustic wave sensing, pressure sensing and optical sensing techniques (but is not limited thereto). Further, the touch detection unit 14 may employ a multi-point sensing technique to identify simultaneously occurring multiple touches.

The touch detection unit 14 may be a touchscreen which is disposed on the display unit 10 or disposed in front of the display unit 10. The touch detection unit 14 may be formed integrally with the display unit 10 or be formed separately from the display unit 10.

Further, the user interface device 100 may be connected to at least one input/output device (not shown). The input/output device may include a keyboard, a printer, a scanner, a camera, or a speaker. The input/output device may be formed integrally with the user interface device 100 or be formed separately from the user interface device 100. Further, the input/output device may be connected to the user interface device 100 through wired connection. Alternatively, the input/output device may be connected to the user interface device 100 through wireless connection.

The user interface device 100 in accordance with this embodiment is configured to recognize a touch gesture of a user applied to the touch detection unit 14 and to control the user interface device 100 based on the gesture. Here, the gesture may be defined as a stylized interaction with an input device and mapped with at least one specific computing operation.

The gesture may be executed through movement of fingers of the user. The touch detection unit 14 receives the gesture, and the control unit 20 executes commands to perform operations related with the gesture. Further, the memory 22 may include the gesture program which is a part of the operating system or a separate application. The gesture program includes a series of commands to recognize generation of gestures and to inform at least one software agent of the gestures and events corresponding to the gestures.

When the user makes at least one gesture, the touch detection unit 14 transmits gesture information to the control unit 20. The control unit 20 analyzes the gesture, and controls the different elements of the user interface device 100, such as the memory, the display unit 10 and the input/output device using commands from the memory 22, more particularly, the gesture program. The gesture may be identified as commands to perform any operation, such as an operation in an application stored in the memory 22, to change the GUI object displayed on the display unit 10, to amend data stored in the memory 22, and to perform an operation in the input/output device.

For example, these commands may be related with zooming, panning, scrolling, turning of pages, rotating, and size adjustment. Further, the commands may be related with starting of a specific program, opening of a file or a document, searching and selection of a menu, execution of a command, logging in to the user interface device 100, allowing of an authorized individual to access a limited area of the user interface device 100, and loading of a user profile related with a user preferred arrangement of a computer background image.

Here, various gestures may be used to execute the commands. For example, a single point gesture, a multi-point gesture, a static gesture, a dynamic gesture, a continuous gesture and a segmented gesture may be used.

The single point gesture is executed at a single touch point. For example, the single point gesture is executed through a single touch using one finger 210, a palm or a stylus.

The multi-point gesture is executed at multiple points. For example, the multi-point gesture is executed through multiple touches using multiple fingers 210, both a finger 210 and a palm, both a finger 210 and a stylus, multiple styluses, and random combinations thereof.

The static gesture is a gesture not including movement, and the dynamic gesture is a gesture including movement. The continuous gesture is a gesture executed through a single stroke, and the segmented gesture is a gesture executed through separate steps or sequences of a stroke.

The user interface device 100 in accordance with this embodiment is configured to simultaneously register multiple gestures. That is, the multiple gestures may be simultaneously executed.

Further, the user interface device 100 in accordance with this embodiment is configured to promptly recognize a gesture so that an operation related with the gesture is executed simultaneously with the gesture. That is, the gesture and the operation are not executed through a two-step process, but are simultaneously executed.

Further, the object provided on the display unit 10 follows gestures which are continuously executed on the touch detection unit 14. There is a one-to-one relationship between the gesture being executed and the object provided on the display unit 10. For example, when the gesture is executed, the object located under the gesture may be simultaneously changed.

Hereinafter, the above-described user interface method using the user interface device 100 having the above configuration will be described in detail.

The display unit 10 displays a GUI, and the touch detection unit 14 senses a first touch gesture of a user in which at least one of one circle is drawn.

As shown in FIG. 2, a user who intends to input a command using the circular GUI object 16 puts two fingers 200 and 210 on the touch detection unit 14 to execute the first touch gesture. Here, the user may locate the fingers 200 at random positions on the touch detection unit 14. The user simultaneously executes rotating gestures of the fingers 200 and 210 at two touch points where the fingers 200 and 210 are located, in the same direction, and if such gestures correspond to rotating gestures simultaneously generated at the two points such that at least a part of the circle is drawn in each of the rotating gestures, the gestures of the user are judged as the first touch gesture.

The control unit 20 judges whether or not the gestures of the user correspond to the first touch gesture, i.e., whether or not there is user's intention to use the circular GUI object 16. For example, when the touch detection unit 14 detects at least two rotating gestures executed by the fingers 200 and 210 and outputs the at least two rotating gestures to the control unit 20, the control unit 20 judges whether or not a central point between two touch points is within the first error range during execution of the gestures. Further, the control unit 20 judges whether or not a distance between the two touch points is maintained in the second error range during execution of the gestures.

That is, as shown in FIG. 4, when the user executes gestures of moving the two fingers 200 and 210 from two initial touch points P₁ and P₂ to two touch points P₁′ and P₂′ rotated from the initial touch points P₁ and P₂ by a random angle, the control unit 20 judges whether or not the above-described conditions of Equation 1 and Equation 2 are satisfied during execution of the rotating gestures of the user.

If the above conditions of Equation 1 and Equation 2 are satisfied, the control unit 20 judges that the gestures of the user correspond to the first touch gesture in which at least a part of a circle is drawn at the two touch points simultaneously.

On the other hand, if one of the above conditions of Equation 1 and Equation 2 is not satisfied, the gestures of the user are not judged as the first touch gesture, but are judged as constituting a gesture indicating another user's intention or a gesture not intended by the user.

Further, in accordance with another embodiment, the first touch gesture may be defined as including a fixed touch gesture generated at a first touch point and a rotating gesture generated at a second touch point simultaneously with the fixed touch gesture.

As shown in FIG. 13, a user who intends to input a command using the circular GUI object 16 puts two fingers 200 and 210 on the touch detection unit 14 to execute the first touch gesture. Here, the user may locate the fingers 200 and 210 at random positions on the touch detection unit 14. The user fixes one finger 200 to a random position P₂, and executes a rotating gesture of another finger 210.

Here, the control unit 20 may judge whether or not a distance between the first touch point P₁′ and the second touch point P₂ is maintained within the third error range during execution of the gestures.

That is, as shown in FIG. 15, when the user executes a gesture of moving a finger from one initial touch point P₁ to another touch point P₁′ rotated from the initial touch point P₁ by a random angle, the control unit 20 judges whether or not the condition of Equation 3 is satisfied during execution of the rotating gesture of the user.

If the above condition of Equation 3 is satisfied, the gestures of the user are judged as the first touch gesture. On the other hand, if the above condition of Equation 3 is not satisfied, the gestures of the user are not judged as the first touch gesture, but are judged as a gesture indicating another user's intention or a gesture not intended by the user.

The display unit 10 displays the circular GUI object 16 according to the first touch gesture sensed under the control of the control unit 20. As shown in FIG. 5, the circular GUI object 16 may be displayed on the display unit 10 in a semitransparent color.

The touch detection unit 14 senses a second touch gesture of the user through the displayed circular GUI object 16, and then the control unit 20 generates an event corresponding to the second touch gesture.

When the user, using the finger 210, initially touches the circular GUI object 16 or a position around the circular GUI object 16, the control unit 20 judges that the circular GUI object 16 is related with the finger 210. Thereby, the circular GUI object 16 is changed according to the gesture of the user finger 210. By relating the finger 210 with the circular GUI object 16, as described above, the circular GUI object 16 is continuously changed on the touch detection unit 14 according to the gesture of the user finger 210.

As shown in FIG. 6, the second touch gesture may be a touch gesture of the user touching and rotating the circular GUI object 16. Although FIG. 6 exemplarily illustrates rotation of the circular GUI object 16 by the user using one finger 210, rotation of the circular GUI object 16 by the user using two fingers 200 and 210, as shown in FIG. 2, may be executed. That is, by executing the first touch gesture, as described above, the user may input the second touch gesture through continuous motion with the first touch gesture when the GUI object 16 is displayed. Alternatively, after the first touch gesture is executed and the circular GUI object 15 is displayed, the second touch gesture is input through discontinuous motion from the first touch gesture.

Here, rotation of the circular GUI object 16 may be adjusted according to a rotating amount of the finger 210. That is, if a gesture of rotating the user finger 210 by an angle of 10 degrees is input, the control unit 20 controls the display unit 10 so that a state in which the circular GUI object 16 is rotated by the angle of 10 degrees is displayed. Rotation of the circular GUI object 16 may be carried out simultaneously with rotation of the finger 210. That is, the circular GUI object 16 may be rotated by an angle of 1 degree almost simultaneously with rotation of the finger 210 by the angle of 1 degree.

Further, in this instance, an acoustic feedback of rotation per unit may be provided according to the above rotation of the circular GUI object 16. For example, a click sound may be provided five times based on rotation by an angle of 10 degrees. Further, a vibration feedback or other tactile feedback having a designated amount to respective click sound may be provided, thereby enabling the virtual circular GUI object 16 to simulate operation of an actual dial.

The touch detection unit 14 detects rotating speed and direction of the second touch gesture, and the control unit 20 controls the display unit 14 so as to rotate the circular GUI object 16 according to the rotating speed and direction of the second touch gesture and adjusts progressing speed and direction of the event according to rotating speed and direction of the circular GUI object 16.

Thereafter, the touch detection unit 14 senses completion of the second touch gesture and outputs a signal corresponding to completion of the second touch gesture to the control unit 20. Further, the control unit 20 controls the display unit 10 so as to remove the circular GUI object 16 when a predetermined time from completion of the second touch gesture has elapsed. If input of the second gesture has been completed or if the circular GUI object 16 is displayed by input of the first touch gesture and then the second touch gesture is not input, when a predetermined time, for example, 0.5 seconds, has elapsed, the control unit 20 judges that there is no user's intention to input the second touch gesture and thus removes the circular GUI object 16 from the display unit 10, as shown in FIG. 12.

As is apparent from the above description, one embodiment of the present invention provides a touch-based user interface device and method which is more intuitive and to which a wider variety of applications is applicable.

It will be apparent to those skilled in the art that various modifications and variations can be made in the present invention without departing from the spirit and scope of the invention. Thus, it is intended that the present invention covers the modifications and variations of this invention provided they come within the scope of the appended claims and their equivalents.

What is claimed is:

1. A touch based user interface method using a user interface device, the method comprising:
sensing, via the user interface device, a first touch gesture on a touch screen in which at least a part of a circle is drawn;
displaying, via the user interface device, a circular graphical user interface (GUI) object according to the sensed first touch gesture;
sensing, via the user interface device, a second touch gesture on the touch screen through the displayed circular GUI object; and
generating, via the user interface device, an event corresponding to the second touch gesture.

2. The method according to claim 1, wherein the first touch gesture includes rotating gestures simultaneously generated at two touch points such that each of the rotating gestures draws part of a circle.

3. The method according to claim 2, wherein the sensing of the first touch gesture includes:
judging whether a central point between the two touch points is within a first error range during execution of the rotating gestures; and
judging whether a distance between the two touch points is maintained within a second error range during execution of the rotating gestures.

4. The method according to claim 1, wherein the first touch gesture includes a fixed touch gesture generated at a first touch point and a simultaneously rotating gesture generated with the fixed touch gesture at a second touch point.

5. The method according to claim 4, wherein the sensing of the first touch gesture includes:
judging whether a distance between the first touch point and the second touch point is maintained within a third error range during execution of the fixed touch gesture and the rotating gesture.

6. The method according to claim 1, wherein the second touch gesture includes contacting and rotating the circular GUI object.

7. The method according to claim 6, further comprising:
detecting rotating speed and direction of the second touch gesture; and
rotating the circular GUI object according to the rotating speed and direction of the second touch gesture.

8. The method according to claim 7, wherein a progressing speed of the event is adjusted according to the rotating speed and direction of the second touch gesture.

9. The method according to claim 1, further comprising:
sensing completion of the second touch gesture; and
removing the circular GUI object after a predetermined time from completion of the second touch gesture has elapsed.

10. The method according to claim 1, wherein the circular GUI object has a semi-transparent appearance.

11. A touch based user interface device comprising:
a display unit configured to display a circular graphical user interface (GUI);
a touch detection unit configured to sense touch gestures of a user through the GUI; and
a control unit configured to generate events respectively corresponding to the touch gestures, wherein:
the touch detection unit is further configured to sense a first touch gesture on a touch screen in which at least a part of a circle is drawn;
the control unit is further configured to control the display unit so as to display a circular GUI object according to the sensed first touch gesture; and
the touch detection unit is further configured to sense a second touch on the touch screen through the displayed circular GUI object; and
the control unit is further configured to generate an event corresponding to the second touch gesture.

12. The device according to claim 11, wherein the touch detection unit is further configured to sense rotating gestures, simultaneously generated at two touch points such that each of the rotating gestures draws part of the circle, as the first touch gesture and output the sensed first touch gesture to the control unit.

13. The device according to claim 12, wherein the touch detection unit is further configured to sense the rotating gestures as the first touch gesture and output the sensed first touch gesture to the control unit if a central point between the two touch points is within a first error range during execution of the rotating gestures, and a distance between the two touch points is maintained within a second error range during execution of the rotating gestures.

14. The device according to claim 11, wherein the touch detection unit is further configured to sense a fixed touch gesture generated at a first touch point and a rotating gesture simultaneously generated at a second touch point with the fixed touch gesture as the first touch gesture and output the sensed first touch gesture to the control unit.

15. The device according to claim 14, wherein the touch detection unit is further configured to sense the fixed touch gesture and the rotating gesture as the first touch gesture and output the sensed first touch gesture to the control unit if a distance between the first touch point and the second touch point is maintained within a third error range during execution of the fixed touch gesture and the rotating gesture.

16. The device according to claim 11, wherein the touch detection unit is further configured to sense a gesture including contacting and rotating the circular GUI object as the second touch gesture and output the sensed second touch gesture to the control unit.

17. The device according to claim 11, wherein the touch detection unit is further configured to detect rotating speed and direction of the second touch gesture, and the control unit is further configured to control the display unit so as to rotate the circular GUI object according to the rotating speed and direction of the second touch gesture.

18. The device according to claim 17, wherein the control unit is further configured to adjust a progressing speed of the event according to the rotating speed and direction of the second touch gesture.

19. The device according to claim 11, wherein the touch detection unit is further configured to sense completion of the second touch gesture, and the control unit is further configured to control the display unit so as to remove the circular GUI object after a predetermined time from completion of the second touch gesture has elapsed.

20. The device according to claim 11, wherein the display unit is further configured to output the circular GUI object in a semi-transparent appearance.
